(19) United States
(12) Patent Application Publication
(10) Pub. No.: US 2014/0234603 A1
(43) Pub. Date: Aug. 21, 2014

(54) Fiber reinforced plastic profiles having sections with different fiber types

(71) Applicant: Airbus Operations GmbH, Hamburg (DE)

(72) Inventor: Sven Werner, Buxtehude (DE)

(21) Appl. No.: 14/177,741

(22) Filed: Feb. 11, 2014

Related U.S. Application Data
(60) Provisional application No. 61/765,063, filed on Feb. 15, 2013.

(30) Foreign Application Priority Data
Feb. 15, 2013 (EP) 13155436.2

(51) Int. Cl. B64C 1/00; B64G 1/22; B32B 5/12

(52) U.S. Cl. CPC B64C 1/00; B32B 5/12; B64G 1/22
USPC 428/218; 156/62.8; 428/222; 428/212

(57) ABSTRACT

A fiber reinforced plastic profile, in particular for an aircraft or spacecraft, including a stacked ply assembly including a plurality of stacked plies each comprising fiber material, the ply assembly having a profile cross section including at least one first section, at least one second section, and at least one splice section located between the at least one first section and the at least one second section. The splice section includes a first plurality of stacked plies having fibers of a first fiber material and a second plurality of stacked plies having fibers of a second fiber material. In the splice section, respective plies of the first plurality of stacked plies are intertwiningly abutted with respective plies of the second plurality of stacked plies.

### CROSS-REFERENCES TO RELATED APPLICATIONS

This application claims the benefit of the U.S. Provisional Application No. 61/765,063, filed on Feb, 15, 2013, and of the European patent application No. 13154436.2 filed on Feb. 15, 2013, the entire disclosures of which are incorporated herein by way of reference.

### FIELD OF THE INVENTION

The present invention pertains to fiber reinforced plastic (FRP) profiles having sections with different fiber types, in particular for use in manufacturing frame, stringer or cross beam components of aircraft or spacecraft. The invention also pertains to a method of forming a fiber reinforced plastic (FRP) profile having sections with different fiber types.

### BACKGROUND OF THE INVENTION

The document US 2012/0308770 A1 discloses a method of manufacturing a composite structural member wherein a stack of fiber reinforced laminate plies with first and second ply portions is laid up, the first and second ply portions containing fibers with different characteristics.

The document EP 1 547 756 A1 discloses a composite material aircraft component with laid up layers of fiber material of a first type and of a second type, the first and second type fiber material forming different sections of the component profile.

Such fiber reinforced plastic profiles with varying lay-ups or hybrid lay-ups may not be suited to cater to the needs of different regions of the profile, especially for structural components serving multiple purposes in the fuselage of an aircraft of spacecraft.

### SUMMARY OF THE INVENTION

It is therefore one idea of the present invention to provide fiber reinforced plastic (FRP) profiles for aircraft or spacecraft components that have varying properties at different sections of the profile cross-section. Another idea of the invention is to save weight of an aircraft or spacecraft by obviating the need to use multiple components for the attachment of structural components to other structural elements of the aircraft or spacecraft.

According to a first aspect of the present invention, a fiber reinforced plastic profile, in particular for an aircraft or spacecraft, comprises a stacked ply assembly including a plurality of stacked plies each comprising fiber material, the ply assembly having a profile cross section comprising at least one first section, at least one second section, and at least one splice section located between the at least one first section and the at least one second section. The splice section includes a first plurality of stacked plies having fibers of a first fiber material and a second plurality of stacked plies having fibers of a second fiber material. In the splice section, respective plies of the first plurality of stacked plies are intertwiningly abutted with respective plies of the second plurality of stacked plies.

According to a second aspect of the present invention, an aircraft or spacecraft comprises at least one fiber reinforced plastic profile according to the first aspect of the invention.

According to a third aspect of the present invention, a method for forming a fiber reinforced plastic profile comprises laying up a first plurality of plies having fibers of a first fiber material to a first stacked ply assembly, and laying up a second plurality of plies having fibers of a second fiber material to a second stacked ply assembly. The respective plies of the first plurality of stacked plies are intertwiningly abutted with respective plies of the second plurality of stacked plies, so that the first stacked ply assembly and the second stacked ply assembly form a respective first section and a respective second section of a profile cross section of a fiber reinforced plastic profile.

One main idea of the present invention is to form a fiber reinforced plastic profile using a plurality of pre-preg or textile plies, the profile having at least one first section and one second section. The first section and the second section include plies of different fiber material. The first and second sections are spliced together at a splicing section where the plies of different fiber material are intertwiningly bonded. In particular, the different layers of plies abutting each other in the splicing section may be intermeshed in a zig-zag fashion in order to create a stable and uniform bond between the first and second sections.

Such a fiber reinforced plastic profile has the advantage that different fiber properties of the different plies may be adapted to the differing requirements of the profile along the layer plane.

Advantageously, terminal or distal ends of the profile may be optimized for inter-rivet buckling resistance with regard to fiber choice. Carrier sections may be optimized for web buckling resistance or resistance to compression after impact (CAI) or tension after impact (TAI). Finally, other areas like bends or corners may be optimized for reduced probability of unfolding.

Furthermore, an advantage is that the profiles may be optimized for lower costs and lower system weight since areas with less critical requirements may be formed from less expensive and/or lighter fiber materials.

The dependent claims provide additional technical features of advantageous embodiments and further improvements of the invention.

According to an embodiment of the fiber reinforced plastic profile, the fiber reinforced plastic profile may form a stringer, frame or cross beam of an aircraft or spacecraft.

According to a further embodiment of the fiber reinforced plastic profile, the fiber reinforced plastic profile may comprise carbon fiber material or naturally grown fiber material.

According to a further embodiment of the fiber reinforced plastic profile, the fibers of the first fiber material and the fibers of the second fiber material may have different moduli of elasticity.

According to a further embodiment of the fiber reinforced plastic profile, the fibers of the first fiber material and the fibers of the second fiber material may have different mass densities.

According to a further embodiment of the fiber reinforced plastic profile, the fibers of the first fiber material and the fibers of the second fiber material may have different tensile strengths.

According to a further embodiment of the fiber reinforced plastic profile, the fibers of the first fiber material and the fibers of the second fiber material may have different stiffness.

According to a further embodiment of the fiber reinforced plastic profile, the fiber reinforced plastic profile may form an a-profile, a Z-profile, an L-profile, an I-profile or a T-profile.

The invention will be explained in greater detail with reference to exemplary embodiments depicted in the drawings as appended.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 shows a schematic illustration of a fiber reinforced plastic profile according to an embodiment of the invention.

FIG. 2 shows a schematic illustration of a profile cross section of a fiber reinforced plastic profile according to another embodiment of the invention.

FIG. 3 shows a schematic illustration of a splice section of a fiber reinforced plastic profile according to yet another embodiment of the invention.

FIG. 4 shows a schematic illustration of a method for forming a fiber reinforced plastic profile according to yet another embodiment of the invention.

### DETAILED DESCRIPTION OF THE PREFERRED EMBODIMENTS

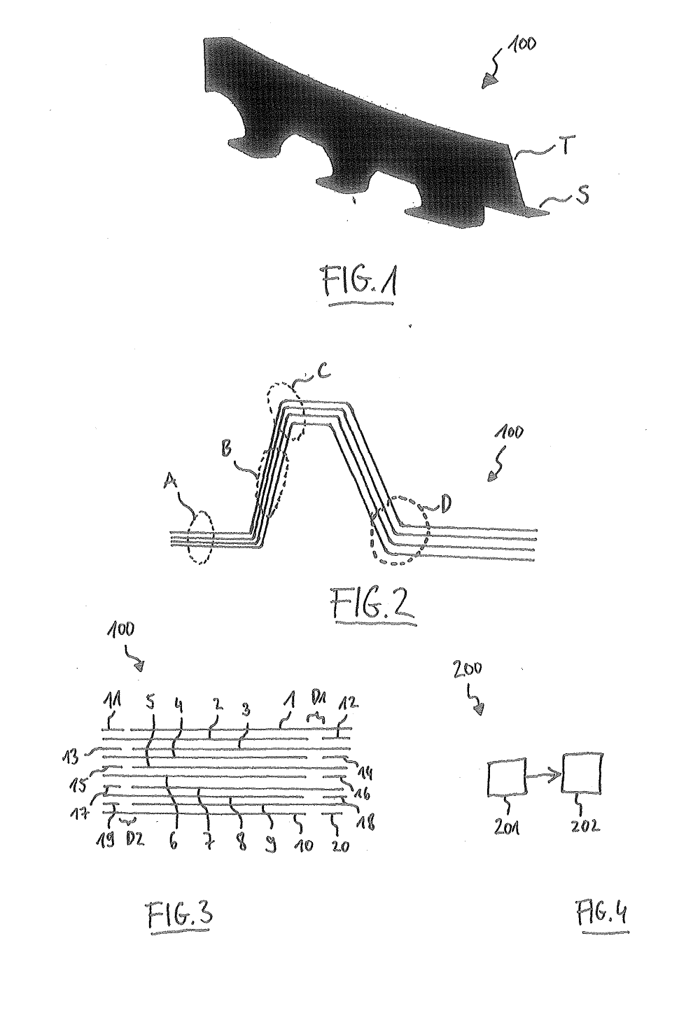

FIG. 1 shows a schematic illustration of a fiber reinforced plastic (FRP) profile 100. The FRP profile 100 is exemplarily shown as Ω-profile, however, other profile types such as L-profiles, I-profiles, H-profiles, T-profiles or Z-profiles are possible for the FRP profile 100 as well. The FRP profile 100 comprises an frame section S and a clip section T. The clip section T mainly has the function of stabilizing the FRP profile 100 and accordingly the structure of the fuselage or wing of the aircraft or spacecraft in which it is used in.

For example, the FRP profile 100 may be a frame for an aircraft, where the beam section T and the clip section S act together to guarantee the structural stability of the fuselage. The section S is used to facilitate attachment of the FRP profile 100 to other structural components of the aircraft such as formers. The main function of the frame is to provide mechanical stability and good load transfer properties. The FRP profile 100 may of course also be used for the manufacture of stringers, longerons, frames, formers, cargo floor components, PAX floor components or cross beams.

FIG. 2 schematically shows the cross section of an FRP profile 100. The cross section may have different regions or sections A, B, C and D corresponding to different areas along the extension of the cross section. For example, the section A at a terminal end of the FRP profile 100 may be a riveting area, which is to be optimized with regard to resistance to inter rivet buckling. The section B may be a vertical carrier section experiencing high loads, so that this section might be optimized with regard to web buckling. The section C may be a transverse carrier section that needs to be optimized with regard to compression after impact (CAI) or tension after impact (TAI). Finally, the section D may be a corner or edge section which might need to be optimized against delamination or unfolding.

The sections A, B, C and D may be formed from stacked ply assemblies of one or more stacked plies. The stacked plies may be chosen so as to have different fiber materials in different sections, according to the respective optimization needs in the sections. The sections A, B, C and D may be joined by respective splice sections at which the different plies of the stacked ply assemblies may be connected.

FIG. 3 schematically illustrates such a splice section of an FRP profile 100. The splice section shows the stacked ply assembly of the FRP profile 100 including a plurality of stacked plies 1 to 20 each comprising fiber material, for example carbon fiber material or naturally grown fiber material.

The splice section may be a joining section between two of the sections A, B, C and D as explained in FIG. 2. For example, on the right side of the splice section, section C may be located, whereas on the left side of the splice section, section D may be located. Accordingly, the splice section includes a first plurality of stacked plies 1, 3, 5, 7, 9 as well as 12, 14, 16, 18, 20 which belong to an end portion of one of the sections A, B, C or D. On the other hand, the splice section includes a second plurality of stacked plies 2, 4, 6, 8, 10 as well as 11, 13, 15, 17, 19 which belong to an end portion of an adjoining one of the sections A, B, C or D.

The first plurality of stacked plies may have in at least some of the stacked plies fibers of a first fiber material. Correspondingly, the second plurality of stacked plies may have in at least some of the stacked plies fibers of a second fiber material. The first and second fiber material may be different from each other, for example with respect to their moduli of elasticity, their mass densities, their tensile strengths, or their stiffness.

Respective plies of the first plurality of stacked plies are intertwiningly abutted with respective plies of the second plurality of stacked plies, i.e., the splice gaps D1 and D2 between each two corresponding layers of plies in the splice section are arranged laterally displaced with regard to each other in an alternating fashion. For example, the splice gap D1 between the layers of plies 2 and 12 is laterally displaced along the extension of the FRP profile 100 against the splice gap D2 between the layers of plies 3 and 13. The following pair of layers 4 and 14 underneath the layers of plies 3 and 13 may then have a splice gap D1 which laterally corresponds to the splice gap D1 between the layers of plies 2 and 12. In that way, the splice gaps D1 and D2 are displaced with regard to the foregoing splice gap in a zig-zag fashion when contemplating a perpendicular cross section through the FRP profile 100.

The number of plies as shown in FIG. 3 is only exemplarily set to 20 and it will be of course possible to use a different number of pairs of plies in the stacked ply assembly. Moreover, the stacked ply assembly may be sandwiching further continuous layers of plies that are not necessarily changing their fiber type in a splice section. Furthermore, it may be possible to provide additional layers of plies above and below the stacked ply assembly.

The plies of the stacked ply assembly may in particular be prepreg plies, i.e., semimanufactured ply layers having unidirectional fibers, a weave of fibers with different fiber directions or a lay-up of multiple fiber weaves. Prepregs as used in this invention may be any duroplastic semimanufactured fabric reinforced by composite fiber material.

FIG. 4 shows a schematic illustration of a method 200 for forming a fiber reinforced plastic profile, especially of a fiber reinforced plastic profile 100 for an aircraft or spacecraft as shown in conjunction with FIGS. 1 to 3.

At 201, a first plurality of plies having fibers of a first fiber material are laid up to a first stacked ply assembly. At 202, a second plurality of plies having fibers of a second fiber material are then laid up to a second stacked ply assembly. When laying up the stacked ply assemblies, the respective plies of the first plurality of stacked plies are intertwiningly abutted with respective plies of the second plurality of stacked plies, so that the first stacked ply assembly and the second stacked ply assembly form a respective first section and a respective second section of a profile cross section of a fiber reinforced plastic profile.

In the foregoing detailed description, various features are grouped together in one or more examples or examples with the purpose of streamlining the disclosure. It is to be understood that the above description is intended to be illustrative, and not restrictive. It is intended to cover all alternatives, modifications and equivalents. Many other examples will be apparent to one skilled in the art upon reviewing the above specification.

The embodiments were chosen and described in order to best explain the principles of the invention and its practical applications, to thereby enable others skilled in the art to best utilize the invention and various embodiments with various modifications as are suited to the particular use contemplated. In the appended claims and throughout the specification, the terms “including” and “in which” are used as the plain-English equivalents of the respective terms “comprising” and “wherein,” respectively.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1. A fiber reinforced plastic profile, the profile comprising:
a stacked ply assembly including a plurality of stacked plies each comprising fiber material,
the ply assembly having a profile cross section comprising at least one first section, at least one second section, and at least one splice section located between the at least one first section and the at least one second section,
the splice section including a first plurality of stacked plies having fibers of a first fiber material and a second plurality of stacked plies having fibers of a second fiber material, and
respective plies of the first plurality of stacked plies being intertwiningly abutted with respective plies of the second plurality of stacked plies.

2. The fiber reinforced plastic profile of claim 1, wherein the fiber reinforced plastic profile forms a stringer, frame or cross beam of an aircraft or spacecraft.

3. The fiber reinforced plastic profile of claim 1, wherein the fiber reinforced plastic profile may comprise carbon fiber material or naturally grown fiber material.

4. The fiber reinforced plastic profile of claim 1, wherein the fibers of the first fiber material and the fibers of the second fiber material have different moduli of elasticity.

5. The fiber reinforced plastic profile of claim 1, wherein the fibers of the first fiber material and the fibers of the second fiber material have different mass densities.

6. The fiber reinforced plastic profile of claim 1, wherein the fibers of the first fiber material and the fibers of the second fiber material have different tensile strengths.

7. The fiber reinforced plastic profile of claim 1, wherein the fibers of the first fiber material and the fibers of the second fiber material have different stiffness.

8. The fiber reinforced plastic profile of claim 1, wherein the fiber reinforced plastic profile forms one of an a-profile, a Ω-profile, an L-profile, an I-profile and a T-profile.

9. An aircraft or spacecraft, comprising at least one fiber reinforced plastic profile, the profile comprising:
a stacked ply assembly including a plurality of stacked plies each comprising fiber material,
the ply assembly having a profile cross section comprising at least one first section, at least one second section, and at least one splice section located between the at least one first section and the at least one second section,
the splice section including a first plurality of stacked plies having fibers of a first fiber material and a second plurality of stacked plies having fibers of a second fiber material, and
respective plies of the first plurality of stacked plies being intertwiningly abutted with respective plies of the second plurality of stacked plies.

10. A method for forming a fiber reinforced plastic profile, comprising:
laying up a first plurality of plies having fibers of a first fiber material to a first stacked ply assembly; and
laying up a second plurality of plies having fibers of a second fiber material to a second stacked ply assembly,
wherein the respective plies of the first plurality of stacked plies are intertwiningly abutted with respective plies of the second plurality of stacked plies, and
wherein the first stacked ply assembly and the second stacked ply assembly form a respective first section and a respective second section of a profile cross section of a fiber reinforced plastic profile.
